(19) United States
(12) Patent Application Publication
(10) Pub. No.: US 2026/0155462 A1
(43) Pub. Date: Jun. 4, 2026

(54) LITHIUM SECONDARY BATTERY, AND METHOD FOR PRODUCING LITHIUM SECONDARY BATTERY

(71) Applicants: TOYOTA JIDOSHA KABUSHIKI KAISHA, Aichi-ken (JP); TOHOKU UNIVERSITY, Miyagi (JP)

(72) Inventors: Daisuke HORIKAWA, Toyota-shi, Aichi-ken (JP); Hiroyuki YAMAGUCHI, Toyota-shi, Aichi-ken (JP); Hiroshi TSUBOUCHI, Nagoya-shi, Aichi-ken (JP); Tetsu ICHITSUBO, Sendai-shi, Miyagi-ken (JP); Hongyi LI, Sendai-shi, Miyagi-ken (JP)

(21) Appl. No.: 18/970,909

(22) Filed: Dec. 6, 2024

(30) Foreign Application Priority Data
Dec. 18, 2023 (JP) 2023-213156

(51) Int. Cl. H01M 10/42; H01M 4/02; H01M 4/04; H01M 4/40

(52) U.S. Cl. CPC H01M 10/4235; H01M 4/0404; H01M 4/405; H01M 2004/027

(57) ABSTRACT

An object of the present disclosure is then to provide a lithium secondary battery with a lithium metal and/or a lithium alloy as a negative electrode active material, in which the lithium secondary battery is enhanced in capacity retention rate, reduced in resistance, and suppressed in short-circuit. A lithium secondary battery, wherein the lithium secondary battery comprises a negative electrode current collector layer, a negative electrode active material layer, a protective layer, an electrolyte layer, a positive electrode active material layer, and a positive electrode current collector layer in the listed order, the negative electrode active material layer contains a lithium metal or a first lithium alloy, and the protective layer contains a second lithium alloy different from the first lithium alloy.

### FIELD

The present disclosure relates to a lithium secondary battery, and a method for producing a lithium secondary battery.

### BACKGROUND

Lithium secondary batteries with lithium metals and/or lithium alloys as negative electrode active materials are large in potential difference between negative electrodes and positive electrodes to achieve a high output voltage, and have a high theoretical capacity density and thus can be expected to be put into practical use, and the following lithium secondary battery is disclosed.

For example, PTL 1 discloses a lithium secondary battery utilizing a deposition-dissolution reaction of a lithium metal, as the reaction of a negative electrode, in which the negative electrode comprises a negative electrode layer, the negative electrode layer contains an alloy of the lithium metal and a dissimilar metal, as a negative electrode active material, and the element ratio of a lithium element in the alloy in full charge of the lithium secondary battery is 40.00 atomic % or more and 99.97 atomic % or less. According to PTL 1, there can be provided a lithium secondary battery which can be enhanced in capacity retention rate.

### CITATION LIST

### Patent Literature

[PTL 1] Japanese Unexamined Patent Publication (Kokai) No. 2023-103517

### SUMMARY

### Technical Problem

Lithium secondary batteries with lithium metals and/or lithium alloys as negative electrode active materials, while are expected to have excellent battery characteristics, are actually low in capacity retention rate and also high in resistance value. Such lithium secondary batteries also have a risk of short-circuit due to formation of lithium dendrite. Therefore, such lithium secondary batteries have room for improvement in terms of capacity retention rate, resistance value, and short-circuit resistance.

An object of the present disclosure is then to provide a lithium secondary battery with a lithium metal and/or a lithium alloy as a negative electrode active material, in which the lithium secondary battery is enhanced in capacity retention rate, reduced in resistance, and suppressed in short-circuit.

### Solution to Problem

The present disclosure is to achieve the above object by the following measures.

### <Aspect 1>

A lithium secondary battery, wherein
the lithium secondary battery comprises a negative electrode current collector layer, a negative electrode active material layer, a protective layer, an electrolyte layer, a positive electrode active material layer, and a positive electrode current collector layer in the listed order,
the negative electrode active material layer contains a lithium metal or a first lithium alloy, and the protective layer contains a second lithium alloy different from the first lithium alloy.

### <Aspect 2>

The lithium secondary battery according to Aspect 1, wherein the second lithium alloy contains lithium and at least one metal element selected from the following:
sodium, magnesium, aluminum, silicon, calcium, zinc, gallium, germanium, strontium, rhodium, palladium, barium, silver, lead, tin, iridium, gold, platinum, and bismuth.

### <Aspect 3>

The lithium secondary battery according to Aspect 1 or 2, wherein the thickness of the protective layer is 5 nm to 10 μm.

### <Aspect 4>

The lithium secondary battery according to any one of Aspects 1 to 3, wherein
the protective layer further contains a third lithium alloy, and
the third lithium alloy is different from the second lithium alloy.

### <Aspect 5>

The lithium secondary battery according to any one of Aspects 1 to 4, wherein the third lithium alloy contains lithium and at least one metal element selected from the following:
sodium, magnesium, aluminum, silicon, calcium, zinc, gallium, germanium, strontium, rhodium, palladium, barium, silver, lead, tin, iridium, gold, platinum, and bismuth.

### <Aspect 6>

The lithium secondary battery according to any one of Aspects 1 to 5, wherein
the negative electrode active material layer contains the first lithium alloy, and
the third lithium alloy is the same as the first lithium alloy.

### <Aspect 7>

A method for producing the lithium secondary battery according to any one of Aspects 1 to 6, the method comprising the following steps of:
forming the negative electrode active material layer on a surface of the negative electrode current collector layer, and
forming a protective layer containing the second lithium alloy, on a surface of the negative electrode active material layer.

### Advantageous Effects of Invention

According to the present disclosure, a lithium secondary battery with a lithium metal and/or a lithium alloy as a negative electrode active material is enhanced in capacity retention rate, reduced in resistance, and suppressed in short-circuit.

### BRIEF DESCRIPTION OF DRAWINGS

FIG. 1 is a schematic view for describing the lithium secondary battery of the present disclosure.

FIG. 2A is a schematic view for describing the method for producing the lithium secondary battery of the present disclosure.

FIG. 2B is a schematic view for describing the method for producing the lithium secondary battery of the present disclosure.

FIG. 2C is a schematic view for describing the method for producing the lithium secondary battery of the present disclosure.

### DESCRIPTION OF EMBODIMENTS

Hereinafter, embodiments of the present disclosure are described in detail. Herein, the present disclosure is not limited to the following embodiments, and can be variously modified and carried out within the gist of the present disclosure. In the description of the drawings, the same symbol is applied to the same element, and the overlapped description is omitted.

In the present disclosure, the “mixture” means a composition which can directly form or further contain any other component to form a positive electrode active material layer or the like. In the present disclosure, the “mixture slurry” means a slurry which contains a dispersion medium in addition to the “mixture”, and thus can be applied and dried to form a positive electrode active material layer or the like.

The lithium secondary battery of the present disclosure may be a liquid-based battery containing an electrolytic solution as an electrolyte layer, or may be a solid-state battery comprising a solid electrolyte layer as an electrolyte layer. In the present disclosure, the “solid-state battery” means a battery with at least a solid electrolyte as an electrolyte, and therefore a combination of a solid electrolyte and a liquid electrolyte may be used as an electrolyte in the solid-state battery. The lithium secondary battery of the present disclosure may be an all-solid-state battery, namely, a battery with only a solid electrolyte as an electrolyte.

### <<Lithium Secondary Battery>>

The lithium secondary battery of the present disclosure comprises
a negative electrode current collector layer, a negative electrode active material layer, a protective layer, an electrolyte layer, a positive electrode active material layer, and a positive electrode current collector layer in the listed order,
the negative electrode active material layer contains a lithium metal or a first lithium alloy, and
the protective layer contains a second lithium alloy different from the first lithium alloy.

According to the present disclosure, a lithium secondary battery with a lithium metal and/or a lithium alloy as a negative electrode active material is enhanced in capacity retention rate, reduced in resistance, and suppressed in short-circuit.

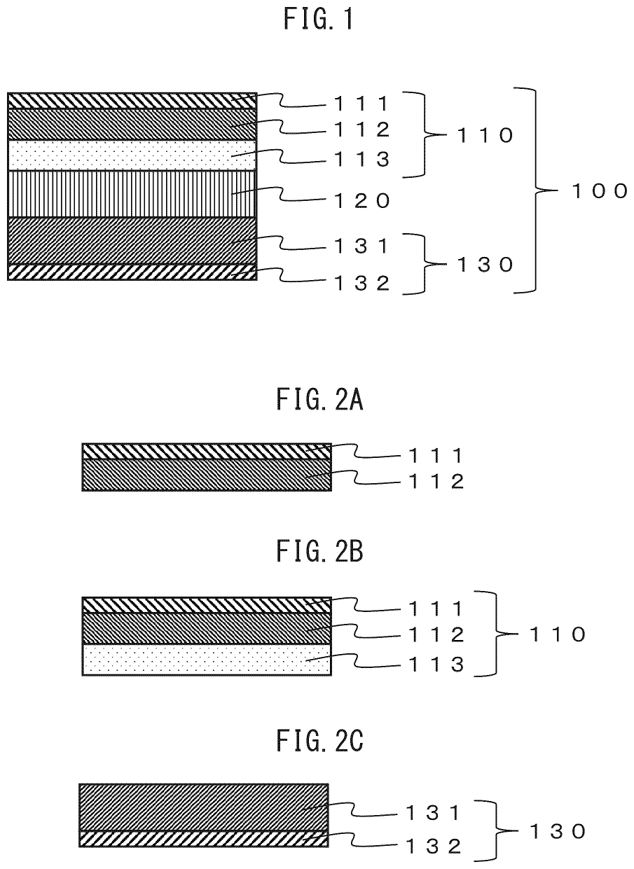

The lithium secondary battery of the present disclosure comprises a negative electrode current collector layer 111, a negative electrode active material layer 112, a protective layer 113, an electrolyte layer 120, a positive electrode active material layer 131, and a positive electrode current collector layer 132 in the listed order, and the protective layer 113 contains a second lithium alloy, specifically, for example, as illustrated in FIG. 1.

Without being limited by theory, the protective layer 113 contains the second lithium alloy and therefore is presumed to be high in lithium ion conductivity and electron conductivity and thus allows the lithium secondary battery to be increased in capacity retention rate and reduced in resistance value. Furthermore, it is presumed that the negative electrode active material layer also contains a lithium metal or a lithium metal alloy and the protective layer and the negative electrode active material layer each contain a similar material containing lithium, therefore the protective layer and the negative electrode active material layer highly adhere at the interface therebetween and thus suppress deposition of dendrite lithium breaking through the protective layer and enhance the short-circuit resistance.

On the other hand, in a case where the protective layer contains no second lithium alloy, it is expected that, not only the capacity retention rate and the resistance value are deteriorated, but also the energy (permeation energy) for allowing a lithium ion to permeate through the protective layer and reach the negative electrode active material layer is higher than the energy of lithium nucleation, thereby causing deposition of lithium dendrite on the protective layer, and short-circuit.

### <Configuration of Lithium Secondary Battery>

The lithium secondary battery of the present disclosure comprises a negative electrode current collector layer, a negative electrode active material layer, a protective layer, an electrolyte layer, a positive electrode active material layer, and a positive electrode current collector layer in the listed order.

### <Negative Electrode Current Collector Layer>

The material used in the negative electrode current collector layer is not particularly limited, and a common negative electrode current collector for lithium secondary batteries can be appropriately selected. Examples of the material used in the negative electrode current collector layer can include Cu, Ni, Cr, Au, Pt, Ag, Al, Fe, Ti, Zn, Co, stainless steel, or a carbon sheet, but not limited to such a case. In particular, the material used in the negative electrode current collector layer may be one containing at least one selected from Cu, Ni and stainless steel or may be one made of a carbon sheet, for example, from the viewpoint of ensuring the reduction resistance and from the viewpoint of hardly alloying with lithium. The negative electrode current collector layer may have any coat layer on the surface thereof for the purpose of, for example, adjustment of the resistance.

The shape of the negative electrode current collector layer is not particularly limited, and examples can include a foil shape, a plate shape, or a mesh shape. In particular, a foil shape is preferred.

The thickness of the negative electrode current collector layer is not particularly limited, and may be 0.1 μm or more, or 1 μm or more, and may be 1 mm or less, or 100 μm or less.

### <Negative Electrode Active Material Layer>

In the lithium secondary battery of the present disclosure, the negative electrode active material layer contains a lithium metal or a first lithium alloy. The negative electrode active material layer is not particularly limited, and preferably contains a first lithium alloy.

In a case where the “negative electrode active material layer” contains a lithium metal, a layer of the lithium metal as the “negative electrode active material layer” is present in a charge state, whereas the lithium metal is moved as a lithium ion to the positive electrode active material layer and no layer of the lithium metal as the “negative electrode active material layer” may be present in a discharge state. Similarly, in a case where the “negative electrode active material layer” contains a first lithium alloy, a layer of the first lithium alloy, as the “negative electrode active material layer”, is present in a charge state, whereas lithium of the first lithium alloy is moved as a lithium ion to the positive electrode active material layer and no first lithium alloy may be present as the “negative electrode active material layer”, and a metal or non-metal layer where lithium is removed from the first lithium alloy may be present in a discharge state.

The negative electrode active material layer contains at least a lithium metal or a first lithium alloy as a negative electrode active material, and may further optionally contain a conductive aid, a binder, a solid electrolyte, and the like. The negative electrode active material layer may contain various other additives. The content of each of the negative electrode active material, the conductive aid, the binder, the solid electrolyte, and the like in the negative electrode active material layer may be appropriately determined depending on the objective battery performance. For example, when the total (total solid content) of the negative electrode active material layer is assumed to be 100% by mass, the content of the negative electrode active material may be 40% by mass or more, 50% by mass or more, 60% by mass or more, and may be 100% by mass or less, or 90% by mass or less.

### (Negative Electrode Active Material)

The negative electrode active material here used is at least a lithium metal or a first lithium alloy, as described above.

### (Negative Electrode Active Material-First Lithium Alloy)

The first lithium alloy is not particularly limited as long as it is an alloy of lithium and a metal element to be alloyed with lithium. The first lithium alloy may be a material that can occlude and release a lithium ion, and examples can include a lithium-aluminum alloy, a lithium-magnesium alloy, and a lithium-silver alloy.

The negative electrode active material layer may contain any other negative electrode active material than the lithium metal or the first lithium alloy. Such other negative electrode active material than the lithium metal or the first lithium alloy is not particularly limited, and examples include a carbon material. Examples of the carbon material include hard carbon, soft carbon, and graphite, but not limited to these cases.

The proportion of the lithium metal or the first lithium alloy contained in the negative electrode active material layer is not particularly limited, and may be 50% by mass to 100% by mass, 60% by mass to 100% by mass, 70% by mass to 100% by mass, 80% by mass to 100% by mass, or 90% by mass to 100% by mass relative to the negative electrode active material layer.

### (Binder)

The binder is not particularly limited. The binder may be, for example, a material such as polyvinylidene fluoride (PVdF), butadiene rubber (BR), polytetrafluoroethylene (PTFE), or styrene-butadiene rubber (SBR), but not limited thereto. The binder is not particularly limited, and may be used singly or in combination of two or more kinds thereof.

### (Conductive Aid)

The conductive aid is not particularly limited. The conductive aid may be, for example, a vapor-grown carbon fiber (VGCF), acetylene black (AB), Ketjen black (KB), a carbon nanotube (CNT), or a carbon nanofiber (CNF), but not limited thereto. The conductive aid may be, for example, particulate or fibrous, and the size thereof is not particularly limited. The conductive aid is not particularly limited, and may be used singly or in combination of two or more kinds thereof.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an argyrodite-type solid electrolyte, but not limited thereto. Specific examples of the sulfide solid electrolyte can include Li₂S—P₂S₅-based solid electrolyte (Li₇P₃S₁₁, Li₃PS₄, Li₂P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, or the like), LiI—Li₂S—P₂O₅, LiI—Li₃PO₄—P₂S₅, or Li₇₋ₓPS₆₋ₓClₓ; or any combination thereof, but not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON), but not limited thereto.

The sulfide solid electrolyte and the oxide solid electrolyte may be each glass or crystallized glass (glass ceramics).

Examples of the polymer electrolyte include polyethylene oxide (PEO), polypropylene oxide (PPO), and any copolymer thereof, but not limited thereto.

The shape of the negative electrode active material is not particularly limited, and may be a shape common to negative electrode active materials for lithium secondary batteries. The negative electrode active material may have, for example, a layer shape or a sheet shape. The negative electrode active material may undergo deposition of lithium during charge, and/or may undergo dissolution of lithium during discharge. In this case, the negative electrode active material layer may be a layer composed of the lithium metal or the lithium alloy.

The shape of the negative electrode active material layer is not particularly limited, and may be, for example, a sheet-shaped negative electrode active material layer having a substantially flat surface. The thickness of the negative electrode active material layer is not particularly limited, and, for example, may be 0.1 μm or more, 1 μm or more, or 10 μm or more, and may be 200 μm or less, 1150 μm or less, or 100 μm or less.

The negative electrode active material layer can be formed with reference to the description of “<<Method for producing lithium secondary battery>>” below.

### <Protective Layer>

In the lithium secondary battery of the present disclosure, the protective layer contains a second lithium alloy different from the first lithium alloy. The protective layer may further contain a third lithium alloy without particular limitations.

In the present disclosure, two alloys being “different” means that the types of metal elements respectively constituting these alloys are different from each other, and does not mean that the types of metal elements respectively constituting these alloys are the same and only the content rates of these metal elements are different. In the present disclosure, two alloys being “the same” means that the types of metal elements respectively constituting these alloys are the same as each other, and accordingly also encompasses a case where the types of metal elements respectively constituting these alloys are the same and only the content rates of these metal elements are different.

The protective layer may further contain any other metal or alloy than the second lithium alloy and the third lithium alloy. The content rate of such any other metal or alloy than the second lithium alloy and the third lithium alloy is not particularly limited, and may be 0% by mass or more, 1% by mass or more, 3% by mass or more, or 5% by mass or more, and may be 50% by mass or less, 20% by mass or less, or 10% by mass or less when the total (total solid content) of the protective layer is assumed to be 100% by mass.

### (Second Lithium Alloy)

The second lithium alloy is not particularly limited as long as it is an alloy of lithium and a metal element to be alloyed with lithium.

The second lithium alloy may contain at least one metal element selected from lithium, and sodium, magnesium, aluminum, silicon, calcium, zinc, gallium, germanium, strontium, rhodium, palladium, barium, silver, lead, tin, iridium, gold, platinum, and bismuth.

The content rate (atomic ratio) of the metal element contained in the second lithium alloy is not particularly limited, and may be 10 atomic % or more, 20 atomic % or more, 30 atomic % or more, 40 atomic % or more, 50 atomic % or more, 60 atomic % or more, or 70 atomic % or more, and may be 90 atomic % or less, 80 atomic % or less, 70 atomic % or less, 60 atomic % or less, 50 atomic % or less, 40 atomic % or less, or 30 atomic % or less in the second lithium alloy.

### (Third Lithium Alloy)

The third lithium alloy is not particularly limited as long as it is an alloy of lithium and a metal element to be alloyed with lithium.

The third lithium alloy may contain at least one metal element selected from lithium, and sodium, magnesium, aluminum, silicon, calcium, zinc, gallium, germanium, strontium, rhodium, palladium, barium, silver, lead, tin, iridium, gold, platinum, and bismuth.

The third lithium alloy is not particularly limited, and is preferably the same as the first lithium alloy from the viewpoint of the capacity retention rate and the resistance value.

The content rate (atomic ratio) of the metal element contained in the third lithium alloy is not particularly limited, and may be 10 atomic % or more, 20 atomic % or more, 30 atomic % or more, 40 atomic % or more, 50 atomic % or more, 60 atomic % or more, or 70 atomic % or more, and may be 90 atomic % or less, 80 atomic % or less, 70 atomic % or less, 60 atomic % or less, 50 atomic % or less, 40 atomic % or less, or 30 atomic % or less in the third lithium alloy.

The thickness of the protective layer is not particularly limited, and may be 5 nm to 10000 nm (10 μm). The thickness of the protective layer is not particularly limited, and may be 5 nm or more, 10 nm or more, 100 nm or more, or 500 nm or more, and may be 10 μm (10000 nm) or less, 5 μm (5000 nm) or less, 1 μm (1000 nm) or less, or 500 nm or less. The thickness of the protective layer can be measured by observation of a cross section of the protective layer with a scanning electron microscope (SEM).

The protective layer can be formed with reference to the description of “<<Method for producing lithium secondary battery>>” below.

### <Electrolyte Layer>

### <Electrolyte Layer-Solid Electrolyte Layer>

The lithium secondary battery of the present disclosure can be a solid-state battery, namely, can have a solid electrolyte layer as the electrolyte layer.

The solid electrolyte layer may contain, if necessary, for example, a binder, in addition to the solid electrolyte.

The solid electrolyte and the binder can be determined with reference to the description of “<Negative electrode active material layer>”.

The thickness of the solid electrolyte layer is not particularly limited, and, for example, may be 0.1 μm or more, 1 μm or more, or 10 μm or more, and may be 2 mm or less, 1 mm or less, or 500 μm or less.

The solid electrolyte layer can be easily formed by, for example, dry or wet molding of an electrolyte mixture containing, for example, the above solid electrolyte and binder.

### <Electrolyte Layer-Separator Layer>

The lithium secondary battery of the present disclosure can be a liquid-based battery, namely, can have an electrolytic solution as the electrolyte layer, in particular, an electrolytic solution retained in a separator layer.

### (Electrolytic Solution)

The electrolytic solution is not particularly limited, and preferably contains a supporting salt and a solvent.

The supporting salt (lithium salt) of an electrolytic solution having lithium ion conductivity is not particularly limited, and examples include an inorganic lithium salt and an organic lithium salt. Examples of the inorganic lithium salt include LiPF₆, LiBF₄, LiClO₄, or LiAsF₆, but not limited to these cases. Examples of the organic lithium salt include LiCF₃SO₃, LiN(CF₃SO₂)₂, LiN(C₂F₅SO₂)₂, LiN(FSO₂)₂, or LiC(CF₃SO₂)₃, but not limited to these cases.

The solvent used in the electrolytic solution is not particularly limited, and examples can include cyclic carbonate or linear carbonate. Examples of the cyclic carbonate can include ethylene carbonate (EC), propylene carbonate (PC), or butylene carbonate (BC), but not limited to such a case. Examples of the linear carbonate include dimethyl carbonate (DMC), diethyl carbonate (DEC), or ethyl methyl carbonate (EMC), but not limited to such a case. The electrolytic solution is not particularly limited, and may be used singly or in combination of two or more kinds thereof.

### (Separator)

The separator is not particularly limited, and a common separator for lithium secondary batteries can be appropriately selected. The separator here used can be, for example, a polyolefin-based, polyamide-based, or polyimide-based non-woven fabric.

### <Positive Electrode Active Material Layer>

The positive electrode active material layer contains at least a positive electrode active material, and may further optionally contain a conductive aid, a solid electrolyte, a binder, and the like. The positive electrode active material layer may contain various other additives. The content of each of the positive electrode active material, the conductive aid, the binder, and the like in the positive electrode active material layer may be appropriately determined depending on the objective battery performance. For example, when the total (total solid content) of the positive electrode active material layer is assumed to be 100% by mass, the content of the positive electrode active material may be 40% by mass or more, 50% by mass or more, 60% by mass or more, and may be 100% by mass or less, or 90% by mass or less.

### (Positive Electrode Active Material)

The material of the positive electrode active material is not particularly limited as long as it can occlude and release a lithium ion. The positive electrode active material may be, for example, lithium cobaltate (LiCoO₂), lithium nickelate (LiNiO₂), lithium manganate (LiMn₂O₄), lithium nickelate/cobaltate/manganate (NCM), LiCO_{1/3}Ni_{1/3}Mn_{1/3}O₂, lithium nickelate/cobaltate/aluminate (NCA; LiNiₓCo_{y}Al₂O₂), or Li—Mn spinel having a composition represented by Li₁₊ₓMn_{2-x-y}M_{y}O₄ (M is one or more elements selected from Al, Mg, Co, Fe, Ni, and Zn) by substitution with a dissimilar element, but not limited thereto.

The positive electrode active material is not particularly limited, and may have a covering layer. The covering layer is a layer containing a substance which has lithium ion conductive performance, which is low in reactivity with the positive electrode active material and the solid electrolyte, and which does not flow even if contacted with the active material or the solid electrolyte and then can allow the form of the covering layer to be kept. Specific examples of the material constituting the covering layer can include Li₄Ti₅O₁₂ or Li₃PO₄, in addition to LiNbO₃, but not limited thereto.

The shape of the positive electrode active material is not particularly limited as long as it is a shape common to positive electrode active materials for lithium secondary batteries. The positive electrode active material may be, for example, particulate. The positive electrode active material may be a primary particle, or may be a secondary particle of a plurality of primary particles aggregated. The average particle size D50 of the positive electrode active material, for example, may be 1 nm or more, 5 nm or more, or 10 nm or more, and may be 500 μm or less, 100 μm or less, 50 μm or less, or 30 μm or less. The average particle size D50 is here a particle size (median size) at which the cumulative value in a particle size distribution on a volume basis, determined by a laser diffraction/scattering method, is 50%.

The solid electrolyte, the binder, and the conductive aid can be determined with reference to the description of “<Negative electrode active material layer>”.

The shape of the positive electrode active material layer is not particularly limited, and may be, for example, a sheet-shaped positive electrode active material layer having a substantially flat surface. The thickness of the positive electrode active material layer is not particularly limited, and, for example, may be 0.1 μm or more, 1 μm or more, or 10 μm or more, and may be 2 mm or less, 1 mm or less, or 500 μm or less.

### <Positive Electrode Current Collector Layer>

The material used in the positive electrode current collector layer is not particularly limited, and a common positive electrode current collector for lithium secondary batteries can be appropriately selected. Examples of the material used in the positive electrode current collector layer can include Cu, Ni, Cr, Au, Pt, Ag, Al, Fe, Ti, Zn, Co, or stainless steel, but not limited to such a case. The positive electrode current collector layer may have any coat layer on the surface thereof for the purpose of, for example, adjustment of the resistance. The positive electrode current collector layer may be a metal foil or substrate on which the above metal is plated or vapor-deposited.

The shape of the positive electrode current collector layer is not particularly limited, and examples can include a foil shape, a plate shape, or a mesh shape. In particular, a foil shape is preferred.

The thickness of the positive electrode current collector layer is not particularly limited, and may be 0.1 μm or more, or 1 μm or more, and may be 1 mm or less, or 100 μm or less.

The positive electrode active material layer can be produced by applying a known method. For example, the positive electrode active material layer can be easily formed by dry or wet molding of a positive electrode mixture containing various components described above. The positive electrode active material layer may be formed together with the positive electrode current collector layer, or may be formed separately from the positive electrode current collector layer.

### <Shape and the Like of Lithium Secondary Battery>

Examples of the shape of the lithium secondary battery include a coin shape, a laminate shape (pouch battery), a cylindrical shape, or a square shape, but not limited to these cases.

FIG. 1 is a schematic view illustrating one aspect of the lithium secondary battery of the present disclosure, but not limited to such a case.

A lithium secondary battery 100 is a battery comprising a negative electrode current collector layer 111, a negative electrode active material layer 112, a protective layer 113, an electrolyte layer 120, a positive electrode active material layer 131, and a positive electrode current collector layer 132 in the listed order. The protective layer 113 placed between the negative electrode active material layer 112 and the electrolyte layer 120 allows the lithium secondary battery to be enhanced in capacity retention rate, reduced in resistance, and suppressed in short-circuit. The protective layer 113 contains the second lithium alloy and is presumed to be high in lithium ion conductivity and electron conductivity and thus allow the lithium secondary battery 100 to be increased in capacity retention rate and reduced in resistance value. Furthermore, it is presumed that the negative electrode active material layer 112 also contains a lithium metal or a lithium metal alloy and the protective layer 113 and the negative electrode active material layer 112 each contain a similar material containing lithium, thereby allowing the protective layer 113 and the negative electrode active material layer 112 to highly adhere at the interface therebetween and thus suppress deposition of dendrite lithium breaking through the protective layer 113 and enhance the short-circuit resistance.

### <<Method for Producing Lithium Secondary Battery>>

The lithium secondary battery of the present disclosure can be produced by a production method comprising the following steps:
forming the negative electrode active material layer on a surface of the negative electrode current collector layer, and
forming a protective layer containing the second lithium alloy, on a surface of the negative electrode active material layer.

According to the method for producing the lithium secondary battery of the present disclosure, it is possible to produce a lithium secondary battery with a lithium metal and/or a lithium alloy as a negative electrode active material, in which the lithium secondary battery is enhanced in capacity retention rate and reduced in resistance, and also suppressed in short-circuit.

### <Formation of Negative Electrode Active Material Layer>

The negative electrode active material layer is not particularly limited, and can be formed by film-forming the lithium metal or the first lithium alloy on a surface of the negative electrode current collector layer by a vapor-deposition system.

### <Formation of Protective Layer>

The protective layer is not particularly limited, and can be formed by film-forming the second lithium alloy on a surface of the negative electrode active material layer by a vapor-deposition system, or can also be formed by film-forming the second lithium alloy and the third lithium alloy at the same time by a vapor-deposition system.

FIG. 2 is a schematic view illustrating one aspect of the method for producing the lithium secondary battery of the present disclosure, but not limited to such a case. The method for producing the lithium secondary battery of the present disclosure is described with FIG. 1 and FIG. 2.

First, a lithium metal or a first lithium alloy is film-formed on a surface of a negative electrode current collector layer 111 by a vapor-deposition system, thereby forming a negative electrode active material layer 112 (FIG. 2A). Next, a second lithium alloy can be film-formed on a surface of a negative electrode active material layer 112 by a vapor-deposition system, thereby forming a protective layer 113, to form a negative electrode laminate 110 where the negative electrode current collector layer 111, the negative electrode active material layer 112, and the protective layer 113 are stacked in the listed order (FIG. 2B). Next, a positive electrode mixture can be applied onto a positive electrode current collector layer 132 in a wet or dry manner, thereby forming a positive electrode active material layer 131, to form a positive electrode laminate 130 (FIG. 2C). Thereafter, the negative electrode laminate 110, an electrolyte layer 120, and the positive electrode laminate 130 can be stacked, thereby forming a lithium secondary battery 100 comprising the negative electrode current collector layer 111, the negative electrode active material layer 112, the protective layer 113, the electrolyte layer 120, the positive electrode active material layer 131, and the positive electrode current collector layer 132 in the listed order, as illustrated in FIG. 1.

### EXAMPLES

The present disclosure is described in further detail with reference to Examples shown below, but the scope of the present disclosure is not limited to these Examples.

### Example 1

### <Production of Negative Electrode Laminate: Formation of Negative Electrode Active Material Layer and Protective Layer on Negative Electrode Current Collector Layer>

A negative electrode active material layer was formed by film-forming a lithium (Li) metal on one surface of copper (Cu) foil as a negative electrode current collector layer, by a vapor-deposition system. Next, a negative electrode laminate was obtained by film-forming a lithium-tin (Li—Sn) alloy as a second lithium alloy on a surface of a negative electrode active material layer, by a vapor-deposition system, and thus forming a protective layer. The negative electrode laminate was a laminate where the negative electrode current collector layer, the negative electrode active material layer, and the protective layer were stacked in the listed order, and the thickness of the protective layer was 500 nm.

### <Production of Positive Electrode Laminate>

A positive electrode mixture slurry was prepared by mixing LiNi_{1/3}Co_{1/3}Mn_{1/3}O₂ (84 parts by mass) as a positive electrode active material, acetylene black (12 parts by mass) as a conductive aid, PVdF (4 parts by mass) as a binder, and a moderate amount of N-methyl-2-pyrrolidone (NMP) as a dispersion medium. Next, the resulting positive electrode mixture slurry was applied onto aluminum (Al) foil as a positive electrode current collector, and dried, thereby producing a positive electrode laminate in which a positive electrode active material layer was formed on a positive electrode current collector layer.

### <Production of Lithium Secondary Battery>

The negative electrode laminate and the positive electrode laminate were stacked so as to be opposite with a polyolefin film (film thickness 20 μm) as a separator being interposed therebetween, and wound in a spiral manner. Respective terminals were connected to the negative electrode laminate and the positive electrode laminate wound, and were received in a battery case, 1 M LiPF₆ ethylene carbonate (EC)/dimethyl carbonate (DMC) (1/1 (volume ratio)) as an electrolytic solution was injected thereinto, and the battery case was sealed, to produce a lithium secondary battery.

### <Formation of Lithium Secondary Battery and Evaluation of Capacity Retention Rate Thereof>

The lithium secondary battery was charged and discharged for 200 cycles with a constant-current (current rate 1 C) system in a cut-off voltage range of 3.3 to 4.2 V at 25° C. The capacity was measured at the first cycle and the 200-th cycle, and the capacity retention rate (Capacity retention rate=(Capacity at 200-th cycle)/(Capacity at first cycle)×100) was calculated. Table 1 shows the results of the capacity retention rate. The capacity retention rate in Table 1 is a relative value in a case where the capacity retention rate of the lithium secondary battery in Comparative Example 1 is 1.00.

### <Evaluation of Resistance Value of Lithium Secondary Battery>

The lithium secondary battery was adjusted so that the open voltage was 3.70 V. Next, the voltage drop (ΔV) was acquired in discharge at −10° C. and a current rate of 5 C for 8 seconds, and the resistance value (current value at a resistance value of ΔV/5 C) was calculated. Table 1 shows the results of the resistance value. The resistance value in Table 1 is a relative value in a case where the resistance value of the battery in Comparative Example 1 is 1.00.

### <Evaluation of Short-Circuit of Lithium Secondary Battery>

The lithium secondary battery was charged at a constant current (current rate 1/3C) with the upper limit charge voltage as 3.5 V. Next, the lithium secondary battery was paused for 10 minutes, and the voltage was increased to 4.5 V. Thereafter, the lithium secondary battery was paused for 10 minutes, and the voltage was measured. A case where the voltage after pausing was 3.5 V or more was determined to as “Not short-circuited”, and a case where the voltage after pausing was less than 3.5 V was determined to as “Short-circuited”. Table 1 shows the results of the short-circuit.

### Comparative Example 1

### <Production of Negative Electrode Laminate: Formation of Negative Electrode Active Material Layer on Negative Electrode Current Collector Layer>

A negative electrode laminate was produced by film-forming a Li metal on one surface of Cu foil as a negative electrode current collector layer, by a vapor-deposition system, and thus forming a negative electrode active material layer.

### <Production of Lithium Secondary Battery, Evaluation of Capacity Retention Rate Thereof, Evaluation of Resistance Value Thereof, and Evaluation of Short-Circuit Thereof>

A lithium secondary battery was produced with the negative electrode laminate produced in Comparative Example 1, by the same method as in Example 1. The capacity retention rate, the resistance value and the short-circuit of the lithium secondary battery were evaluated by the same methods as in Example 1. In Examples and Comparative Examples herein, each relative value is shown in a case where the capacity retention rate and the resistance value of the lithium secondary battery in Comparative Example 1 are each 1.00.

### Example 2

### <Production of Negative Electrode Laminate: Formation of Negative Electrode Active Material Layer and Protective Layer on Negative Electrode Current Collector Layer>

A negative electrode active material layer containing a first lithium alloy was formed by film-forming lithium (Li) and aluminum (Al) on one surface of Cu foil as a negative electrode current collector layer, by a vapor-deposition system (co-vapor deposition). Next, a negative electrode laminate was obtained by film-forming a Li—Sn alloy as a second lithium alloy on a surface of the negative electrode active material layer, by a vapor-deposition system, and thus forming a protective layer. The negative electrode laminate was a laminate where the negative electrode current collector layer, the negative electrode active material layer, and the protective layer were stacked in the listed order, and the thickness of the protective layer was 500 nm.

### Examples 3 and 4

### <Production of Negative Electrode Laminate: Formation of Negative Electrode Active Material Layer and Protective Layer on Negative Electrode Current Collector Layer>

Each negative electrode laminate was produced by the same method as in Example 2 except that magnesium (Mg) (Example 3) or silver (Ag) (Example 4) was used instead of Al in formation of the negative electrode active material layer.

### Example 5

### <Production of Negative Electrode Laminate: Formation of Negative Electrode Active Material Layer And Protective Layer on Negative Electrode Current Collector Layer>

A negative electrode active material layer containing a first lithium alloy was formed by film-forming Li and Al on one surface of Cu foil as a negative electrode current collector layer, by a vapor-deposition system (co-vapor deposition). Next, a negative electrode laminate was obtained by film-forming a Li—Sn alloy as a second lithium alloy and a lithium-aluminum (Li—Al) alloy as a third lithium alloy at the same time on a surface of the negative electrode active material layer, by a vapor-deposition system, and thus forming a protective layer. The negative electrode laminate was a laminate where the negative electrode current collector layer, the negative electrode active material layer, and the protective layer were stacked in the listed order, and the thickness of the protective layer was 500 nm.

### Examples 6 and 7

<Production of Negative Electrode Laminate: Formation of Negative Electrode Active Material Layer and Protective Layer on Negative Electrode Current Collector Layer>

A negative electrode laminate in Example 6 was produced by the same method as in Example 5 except that Mg was used instead of Al in formation of the negative electrode active material layer and a Li—Mg alloy was used instead of the Li—Al alloy in formation of the protective layer. A negative electrode laminate in Example 7 was produced by the same method as in Example 5 except that Ag was used instead of Al in formation of the negative electrode active material layer and a Li—Ag alloy was used instead of the Li—Al alloy in formation of the protective layer.

### <Production of Lithium Secondary Battery, Evaluation of Capacity Retention Rate Thereof, Evaluation of Resistance Value Thereof, and Evaluation of Short-Circuit Thereof>

A lithium secondary battery was produced with the negative electrode laminate produced in each of Examples 2 to 7, by the same method as in Example 1. The capacity retention rate, the resistance value and the short-circuit of the lithium secondary battery were evaluated by the same methods as in Example 1. The respective results were as shown in Table 1.

### Comparative Example 2

### <Production of Negative Electrode Laminate: Formation of Negative Electrode Active Material Layer and Protective Layer on Negative Electrode Current Collector Layer>

A negative electrode laminate was produced by the same method as in Example 1 except that a compound containing lithium (Li) and iron (Fe), which was not a lithium alloy, was used instead of the Li—Sn alloy as the second lithium alloy in formation of the protective layer.

### Comparative Example 3

### <Production of Negative Electrode Laminate: Formation of Negative Electrode Active Material Layer and Protective Layer on Negative Electrode Current Collector Layer>

A negative electrode laminate was produced by the same method as in Comparative Example 1 except that Li and Ag were film-formed instead of the Li metal by a vapor-deposition system (co-vapor deposition) in formation of the negative electrode active material layer.

### Comparative Example 4

### <Production of Negative Electrode Laminate: Formation of Negative Electrode Active Material Layer and Protective Layer on Negative Electrode Current Collector Layer>

A negative electrode laminate was produced by the same method as in Example 4 except that a compound containing lithium (Li) and iron (Fe), which was not a lithium alloy, was used instead of the Li—Sn alloy as the second lithium alloy in formation of the protective layer.

### <Production of Lithium Secondary Battery, Evaluation of Capacity Retention Rate Thereof, Evaluation of Resistance Value Thereof, and Evaluation of Short-Circuit Thereof>

A lithium secondary battery was produced with the negative electrode laminate produced in each of Comparative Examples 2 to 4, by the same method as in Example 1. The capacity retention rate, the resistance value and the short-circuit of the lithium secondary battery were evaluated by the same methods as in Example 1. The respective results were as shown in Table 1.

TABLE 1

| | Negative | | | | Evaluation results | | |
|---|---|---|---|---|---|---|---|
| | electrode active | Protective layer | | | Capacity retention rate | Resistance value | |
| | material layer | | | Thickness of | relative to Comparative | relative to Comparative | |
| | Li metal or | Second | Third | protective layer | Example 1 | Example 1 | |
| | first Li alloy | Li alloy | Li alloy | [nm] | [—] | [—] | Short-circuit |
| Comparative | Li metal | — | — | — | 1.00 | 1.00 | Short-circuited |
| Example 1 | | | | | | | |
| Example 1 | Li metal | Li—Sn | — | 500 | 1.62 | 0.82 | Not short-circuited |
| Example 2 | Li—Al | Li—Sn | — | 500 | 1.73 | 0.73 | Not short-circuited |
| Example 3 | Li—Mg | Li—Sn | — | 500 | 1.88 | 0.71 | Not short-circuited |
| Example 4 | Li—Ag | Li—Sn | — | 500 | 1.84 | 0.73 | Not short-circuited |
| Example 5 | Li—Al | Li—Sn | Li + Al | 500 | 2.33 | 0.62 | Not short-circuited |
| Example 6 | Li—Mg | Li—Sn | Li + Mg | 500 | 2.44 | 0.59 | Not short-circuited |
| Example 7 | Li—Ag | Li—Sn | Li + Ag | 500 | 2.43 | 0.62 | Not short-circuited |
| Comparative | Li metal | Compound | — | 500 | 1.04 | 1.02 | Short-circuited |
| Example 2 | | containing | | | | | |
| | | Li and Fe | | | | | |
| Comparative | Li—Ag | — | — | — | 1.05 | 0.99 | Short-circuited |
| Example 3 | | | | | | | |
| Comparative | Li—Ag | Compound | — | 500 | 1.08 | 0.99 | Short-circuited |
| Example 4 | | containing | | | | | |
| | | Li and Fe | | | | | |

The lithium secondary battery comprising the protective layer containing the Li—Sn alloy as the second lithium alloy (Examples 1 to 7) was increased in capacity retention rate and decreased in resistance value, and did not cause short-circuit, as compared with the lithium secondary battery comprising no protective layer (Comparative Examples 1 and 3). The lithium secondary battery comprising the protective layer containing the second lithium alloy and the third lithium alloy (Examples 5 to 7) exhibited further favorable capacity retention rate and resistance value. However, the lithium secondary battery comprising the protective layer containing the compound containing Li and Fe, which was not a lithium alloy, (Comparative Examples 2 and 4), was comparative with or slightly worse than a battery comprising no protective layer, in terms of performance thereof.

The protective layer contains the second lithium alloy and is presumed to be high in lithium ion conductivity and electron conductivity, resulting in an increase in capacity retention rate and a reduction in resistance value. Furthermore, it is presumed that the negative electrode active material layer also contains a lithium metal or a lithium metal alloy and the protective layer and the negative electrode active material layer each contain a similar material containing lithium, thereby allowing the protective layer and the negative electrode active material layer to highly adhere at the interface therebetween and thus suppress deposition of dendrite lithium breaking through the protective layer and enhance the short-circuit resistance. On the other hand, in a case where the protective layer contains no second lithium alloy (for example, compound containing Li and Fe), it is presumed that the energy (permeation energy) for allowing a lithium ion to permeate through the protective layer and reach the negative electrode active material layer is higher than the energy of lithium nucleation, thereby causing deposition of lithium dendrite on the protective layer, and a reduction in short-circuit resistance.

### Examples 8 to 25 (Influence of Second Lithium Alloy Contained in Protective Layer)

### <Production of Negative Electrode Laminate: Formation of Negative Electrode Active Material Layer and Protective Layer on Negative Electrode Current Collector Layer>

A negative electrode laminate was produced by the same method as in Example 4 except that a lithium alloy described in Table 2 was used instead of the Li—Sn alloy as the second lithium alloy in formation of the protective layer.

### <Production of Lithium Secondary Battery, Evaluation of Capacity Retention Rate Thereof, Evaluation of Resistance Value Thereof, and Evaluation of Short-Circuit Thereof>

A lithium secondary battery was produced with the negative electrode laminate produced in each of Examples 8 to 25, by the same method as in Example 1. The capacity retention rate, the resistance value and the short-circuit of the lithium secondary battery were evaluated by the same methods as in Example 1. The respective results were as shown in Table 1.

TABLE 2

| | Negative | | | | Evaluation results | | |
|---|---|---|---|---|---|---|---|
| | electrode active | Protective layer | | | Capacity retention rate | Resistance value | |
| | material layer | | | Thickness of | relative to Comparative | relative to Comparative | |
| | Li metal or | Second | Third | protective layer | Example 1 | Example 1 | |
| | first Li alloy | Li alloy | Li alloy | [nm] | [—] | [—] | Short-circuit |
| Comparative | Li metal | — | — | — | 1.00 | 1.00 | Short-circuited |
| Example 1 | | | | | | | |
| Example 8 | Li—Ag | Li—Na | — | 500 | 1.87 | 0.75 | Not short-circuited |
| Example 9 | Li—Ag | Li—Mg | — | 500 | 1.79 | 0.69 | Not short-circuited |
| Example 10 | Li—Ag | Li—Al | — | 500 | 1.75 | 0.72 | Not short-circuited |
| Example 11 | Li—Ag | Li—Si | — | 500 | 1.87 | 0.75 | Not short-circuited |
| Example 12 | Li—Ag | Li—Ca | — | 500 | 1.84 | 0.73 | Not short-circuited |
| Example 13 | Li—Ag | Li—Zn | — | 500 | 1.9 | 0.72 | Not short-circuited |
| Example 14 | Li—Ag | Li—Ga | — | 500 | 1.81 | 0.72 | Not short-circuited |
| Example 15 | Li—Ag | Li—Ge | — | 500 | 1.93 | 0.75 | Not short-circuited |
| Example 16 | Li—Ag | Li—Sr | — | 500 | 1.96 | 0.75 | Not short-circuited |
| Example 17 | Li—Ag | Li—Rh | — | 500 | 1.82 | 0.72 | Not short-circuited |
| Example 18 | Li—Ag | Li—Pd | — | 500 | 1.83 | 0.72 | Not short-circuited |
| Example 19 | Li—Ag | Li—Ba | — | 500 | 1.86 | 0.75 | Not short-circuited |
| Example 20 | Li—Ag | Li—Pb | — | 500 | 1.89 | 0.73 | Not short-circuited |
| Example 21 | Li—Ag | Li—Sn | — | 500 | 1.93 | 0.69 | Not short-circuited |
| Example 22 | Li—Ag | Li—Ir | — | 500 | 1.89 | 0.73 | Not short-circuited |
| Example 23 | Li—Ag | Li—Au | — | 500 | 1.83 | 0.69 | Not short-circuited |
| Example 24 | Li—Ag | Li—Pt | — | 500 | 1.92 | 0.68 | Not short-circuited |
| Example 25 | Li—Ag | Li—Bi | — | 500 | 1.82 | 0.72 | Not short-circuited |

The lithium secondary battery comprising the protective layer containing any other lithium alloy than the Li—Sn alloy, as the second lithium alloy, (Examples 8 to 25), was also increased in capacity retention rate and reduced in resistance, and did not cause short-circuit. It was presumed that the protective layer containing the lithium alloy constituted from various metal elements was higher in lithium ion conductivity and electron conductivity, resulting in an increase in capacity retention rate and a reduction in resistance value.

### Examples 26 to 31 (Influence of Thickness of Protective Layer)

### <Production of Negative Electrode Laminate: Formation of Negative Electrode Active Material Layer and Protective Layer on Negative Electrode Current Collector Layer>

Each negative electrode laminate was produced by the same method as in Example 4 except that the thickness of the protective layer was each thickness described in Table 3, in formation of the protective layer.

### <Production of Lithium Secondary Battery, Evaluation of Capacity Retention Rate Thereof, Evaluation of Resistance Value Thereof, and Evaluation of Short-Circuit Thereof>

A lithium secondary battery was produced with the negative electrode laminate produced in each of Examples 26 to 31, by the same method as in Example 1. The capacity retention rate, the resistance value and the short-circuit of the lithium secondary battery were evaluated by the same methods as in Example 1. The respective results were as shown in Table 1.

TABLE 3

| | Negative | | | | Evaluation results | | |
|---|---|---|---|---|---|---|---|
| | electrode active | Protective layer | | | Capacity retention rate | Resistance value | |
| | material layer | | | Thickness of | relative to Comparative | relative to Comparative | |
| | Li metal or | Second | Third | protective layer | Example 1 | Example 1 | |
| | first Li alloy | Li alloy | Li alloy | [nm] | [—] | [—] | Short-circuit |
| Comparative | Li metal | — | — | — | 1.00 | 1.00 | Short-circuited |
| Example 1 | | | | | | | |
| Example 26 | Li—Ag | Li—Sn | — | 5 | 1.91 | 0.73 | Not short-circuited |
| Example 27 | Li—Ag | Li—Sn | — | 50 | 1.9 | 0.7 | Not short-circuited |
| Example 28 | Li—Ag | Li—Sn | — | 100 | 1.93 | 0.67 | Not short-circuited |
| Example 4 | Li—Ag | Li—Sn | — | 500 | 1.84 | 0.73 | Not short-circuited |
| Example 29 | Li—Ag | Li—Sn | — | 1000 | 1.95 | 0.69 | Not short-circuited |
| Example 30 | Li—Ag | Li—Sn | — | 5000 | 1.94 | 0.71 | Not short-circuited |
| Example 31 | Li—Ag | Li—Sn | — | 10000 | 1.93 | 0.73 | Not short-circuited |

The lithium secondary battery where the thickness of the protective layer was 5 nm to 10000 nm (10 μm) was evaluated in each of Example 4 and Examples 26 to 31. The lithium secondary battery, in which the thickness of the protective layer was within a wide range of 5 nm to 10000 nm (10 μm), was increased in capacity retention rate and reduced in resistance value, and did not cause short-circuit.

Although preferred embodiments of the lithium secondary battery and the method for producing the lithium secondary battery of the present disclosure are described, it is understood by those skilled in the art that modifications can be made without departing from the claims.

### REFERENCE SIGNS LIST

100 Lithium secondary battery
110 Negative electrode laminate
111 Negative electrode current collector layer
112 Negative electrode active material layer
113 Protective layer
120 Electrolyte layer
130 Positive electrode laminate
131 Positive electrode active material layer
132 Positive electrode current collector layer

1. A lithium secondary battery, wherein
the lithium secondary battery comprises a negative electrode current collector layer, a negative electrode active material layer, a protective layer, an electrolyte layer, a positive electrode active material layer, and a positive electrode current collector layer in the listed order,
the negative electrode active material layer contains a lithium metal or a first lithium alloy, and
the protective layer contains a second lithium alloy different from the first lithium alloy.

2. The lithium secondary battery according to claim 1, wherein the second lithium alloy contains lithium and at least one metal element selected from the following:
sodium, magnesium, aluminum, silicon, calcium, zinc, gallium, germanium, strontium, rhodium, palladium, barium, silver, lead, tin, iridium, gold, platinum, and bismuth.

3. The lithium secondary battery according to claim 1, wherein the thickness of the protective layer is 5 nm to 10 μm.

4. The lithium secondary battery according to claim 1, wherein
the protective layer further contains a third lithium alloy, and
the third lithium alloy is different from the second lithium alloy.

5. The lithium secondary battery according to claim 4, wherein
the third lithium alloy contains lithium and at least one metal element selected from the following:
sodium, magnesium, aluminum, silicon, calcium, zinc, gallium, germanium, strontium, rhodium, palladium, barium, silver, lead, tin, iridium, gold, platinum, and bismuth.

6. The lithium secondary battery according to claim 4, wherein
the negative electrode active material layer contains the first lithium alloy, and
the third lithium alloy is the same as the first lithium alloy.

7. A method for producing the lithium secondary battery according to claim 1, the method comprising the following steps of:
forming the negative electrode active material layer on a surface of the negative electrode current collector layer, and
forming a protective layer containing the second lithium alloy, on a surface of the negative electrode active material layer.
